(19) United States
(12) Patent Application Publication
(10) Pub. No.: US 2015/0206464 A1
(43) Pub. Date: Jul. 23, 2015

(54) LANDSCAPE FEATURE PLACEMENT TOOL, SYSTEM, AND METHODS

(71) Applicant: Richard Meinzer, Cedar Hills, UT (US)

(72) Inventor: Richard Meinzer, Cedar Hills, UT (US)

(21) Appl. No.: 14/561,101

(22) Filed: Dec. 4, 2014

Related U.S. Application Data
(60) Provisional application No. 61/912,359, filed on Dec. 5, 2013.

(51) Int. Cl. G09F 17/00

(52) U.S. Cl. CPC G09F 17/00

(57) ABSTRACT

A landscape feature placement tool, system, and associated methods are disclosed. The landscape feature placement tool can comprise a first segment, a second segment pivotally coupled to the first segment, a third segment pivotally coupled to the second segment, a first indicator configured to indicate a first angle between the first segment and the second segment, and a second indicator configured to indicate a second angle between the second segment and the third segment. The first, second, and/or third segments are selectively positioned relative to a reference and the first and/or second angles are selected to determine a location for placement of a landscape feature relative to the reference.

### PRIORITY DATA

This application claims the benefit of U.S. Provisional Patent Application Ser. No. 61/912,359, filed on Dec. 5, 2013, which is incorporated herein by reference.

### FIELD OF THE INVENTION

The present invention relates generally to landscape devices, systems, and associated methods and, particularly, to landscape feature placement tools.

### BACKGROUND OF THE INVENTION

A well thought-out and executed landscape design can greatly enhance the visual appeal of a home or business. Unfortunately, determining locations for landscape features, such as foliage items (i.e., plants, bushes, trees, and flowers), rocks, outdoor lights, etc., can be a frustrating and time consuming endeavor often requiring the services of a landscape architect. Thus, there is a need for a tool or device that can aid in accurately determining, in a simple and efficient manner, design and placement of such landscape features.

### SUMMARY OF THE INVENTION

Accordingly, the present invention provides landscape feature placement tools, systems, and associated methods. In one aspect, for example, a landscape feature placement tool or device is provided. Such a tool can include a first segment, a second segment pivotally coupled to the first segment, a third segment pivotally coupled to the second segment, a first indicator configured to indicate a first angle between the first segment and the second segment, and optionally a second indicator configured to indicate a second angle between the second segment and the third segment. At least one of the first, second, and third segments can be selectively positioned relative to a reference and at least one of the first and second angles can be selected to determine a location for placement of a landscape feature relative to the reference.

The present invention additionally provides a landscape feature placement system. The system can comprise a landscape feature placement tool, having a first segment, a second segment pivotally coupled to the first segment, a third segment pivotally coupled to the second segment, a first indicator configured to indicate a first angle between the first segment and the second segment, and optionally a second indicator configured to indicate a second angle between the second segment and the third segment. At least one of the first, second, and third segments can be selectively positioned relative to a reference and at least one of the first and second angles can be selected to determine a location for placement of a landscape feature relative to the reference. The system can also comprise a plurality of markers to mark the location for placement of a landscape feature.

The present invention also provides a method of placing a landscape feature including placement of features relative to other features. The method can comprise providing or otherwise obtaining a landscape feature placement tool, having a first segment, a second segment pivotally coupled to the first segment, a third segment pivotally coupled to the second segment, a first indicator configured to indicate a first angle between the first segment and the second segment, and optionally a second indicator configured to indicate a second angle between the second segment and the third segment. The method can also comprise determining a first location for a first landscape feature. The method can further comprise placing a first marker at the first location. The method can further comprise determining a second location for a second landscape feature relative to the first location using the landscape feature placement tool, wherein at least one of the first, second, and third segments are selectively positioned relative to the first marker and at least one of the first and second angles are selected to determine the second location. In addition, the method can comprise placing a second marker at the second location. It is noted that no specific order is required in these methods, though generally in some embodiments, the method steps can be carried out sequentially.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1A illustrates a landscape feature placement tool in accordance with an invention embodiment.

FIG. 1B illustrates a detail view of the landscape feature placement tool of FIG. 1A.

FIG. 2 illustrates a landscape feature placement tool in accordance with another invention embodiment.

FIG. 3A illustrates a landscape feature placement tool in accordance with yet another invention embodiment.

FIG. 3B illustrates the landscape feature placement tool of FIG. 3A in a folded or storage configuration.

FIG. 3C illustrates a detailed view of a disassembled pivotal coupling of the landscape feature placement tool of FIG. 3A.

FIG. 4 illustrates a landscape feature placement tool in accordance with still another invention embodiment.

FIG. 5 illustrates a landscape feature placement system in accordance with an invention embodiment.

FIG. 6 illustrates an exploded view of an assembly connecting one segment in the tool to another segment in the tool according to an invention embodiment.

FIG. 7 illustrates a perspective view of a landscape feature placement tool in a retracted or storage condition or state.

FIG. 8 is a top view of the tool in FIG. 6.

FIG. 9 is a bottom view of the tool in FIG. 6.

FIG. 10 is a side view of the tool in FIG. 6.

FIG. 11 is a first end view of the tool in FIG. 6.

FIG. 12 is a second end view of the tool in FIG. 6

FIG. 13 is a top perspective view of the tool in FIG. 6 in a partially deployed condition or state.

The sides of the tool are mirror images of one another.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

In describing and claiming the present invention, the following terminology will be used in accordance with the definitions set forth below.

The singular forms “a,” “an,” and, “the” include plural referents unless the context clearly dictates otherwise. Thus, for example, reference to “a segment” includes reference to one or more of such segment, and reference to “the indicator” includes reference to one or more of such indicators.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected. The term attached is used in a like manner and can refer to either a direct or indirect attachment between objects. “Directly attached” or “directly coupled” refers to objects in direct physical contact with one another. Likewise, “indirectly attached” or “indirectly coupled” refers to objects that are connected by an indirect mechanism, such as by an intermediate object, fixture, or arrangement. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “about” is used to provide flexibility to a numerical range endpoint by providing that a given value may be “a little above” or “a little below” the endpoint. However, it is to be understood that in this specification, the term “about” also affords support for recitation of the exact value with which the term is connected. For example, “about 7” also provides support for the number “7” exactly.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

### Example Embodiments

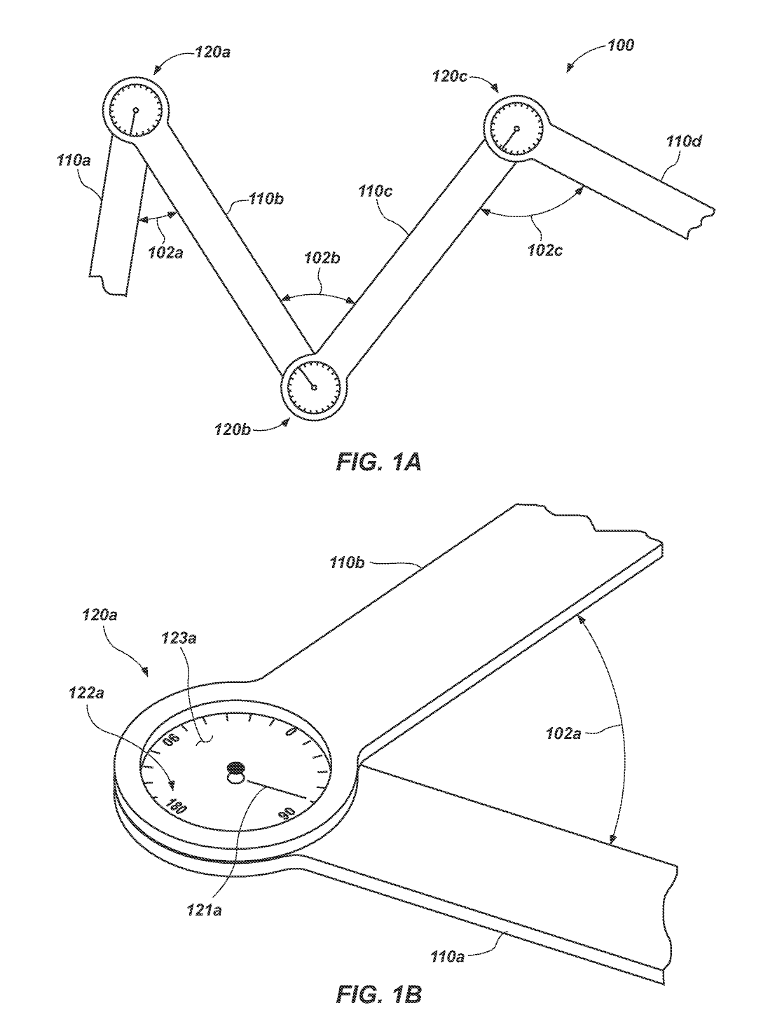

Invention embodiments relate to placing landscape features and, particularly, to a landscape feature placement tool. With reference to FIG. 1A, illustrated is a landscape feature placement tool 100 in accordance with an invention embodiment. The tool can include multiple segments 110a-d pivotally coupled end-to-end such that segment 110a is pivotally coupled to segment 110b, which is pivotally coupled to segment 110c, which is pivotally coupled to segment 110d, and so on with any suitable number of segments. In one embodiment, there can be at least two segments. In another embodiment, there can be at least three segments. In a further embodiment there can be at least 4 segments. In yet another embodiment, there can be at least 5 segments. In additional embodiments, there can be from about 2 to about 100 segments. In another embodiment there can be from about 3 to about 10 segments. In additional embodiments there can be 2, 3, 4, 5, 6, 7, 8, 9, 10, 11, or 12 segments. The segments can be coupled, such as directly coupled, end to end and configured to rotate relative to one another to position and/or locate a given segment at a desired position relative to another segment. The segments can be constructed of any suitable material, such as plastic, wood, metal, rubber, fiberglass, etc. In one aspect, relative rotation of the segments can be resisted by friction between adjacent segments, which can be adjustable to hold or retain the segments in a desired configuration, including at specific angles relative to one another, while using the tool. As will be described in more detail hereinafter, the segments can be manipulated and selectively positioned, relative to a reference, to identify or determine placement locations for landscape features, such as by selecting desired angles between segments and distances as measured by one or more of the segments.

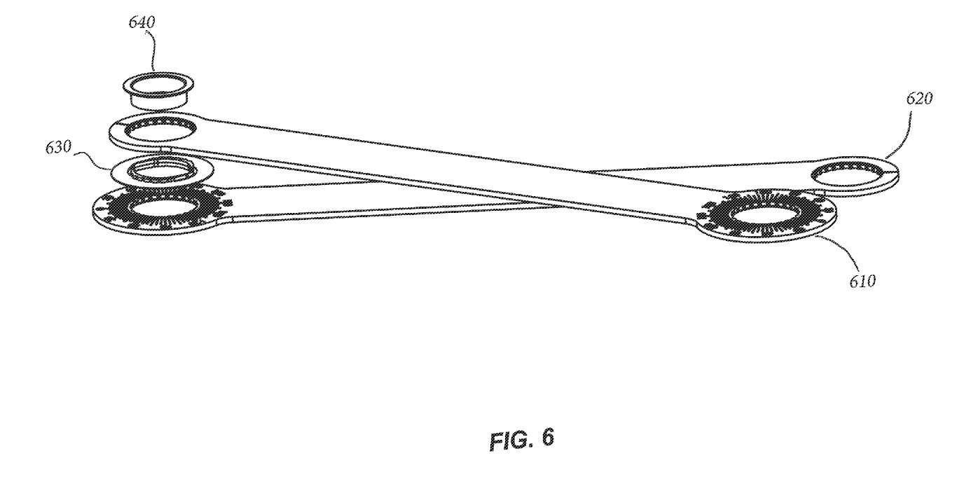

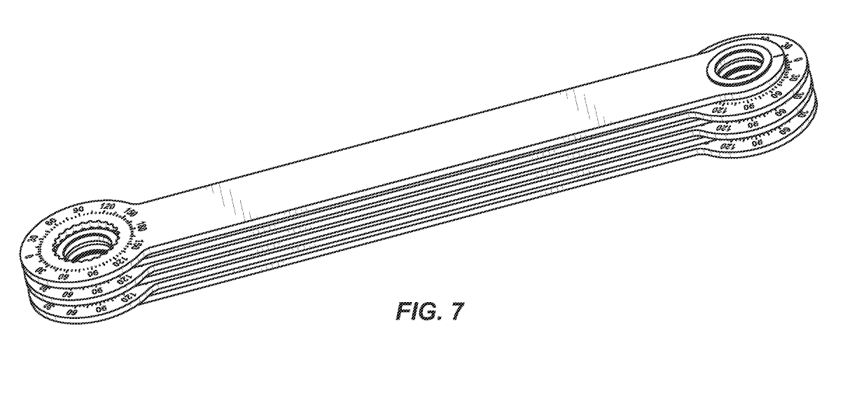

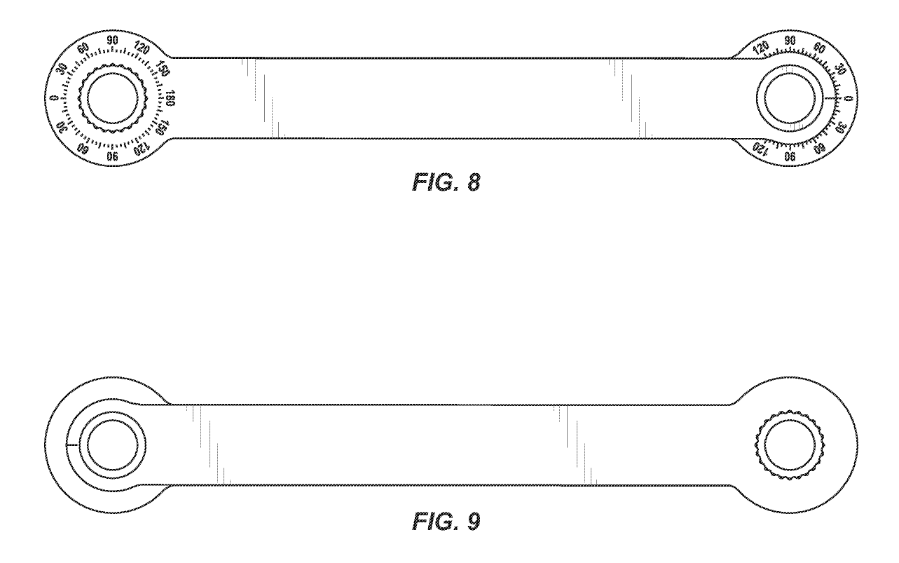

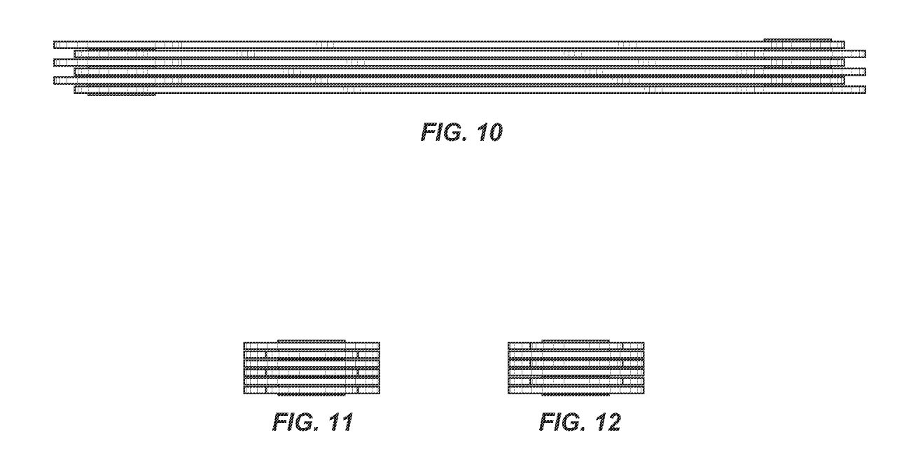

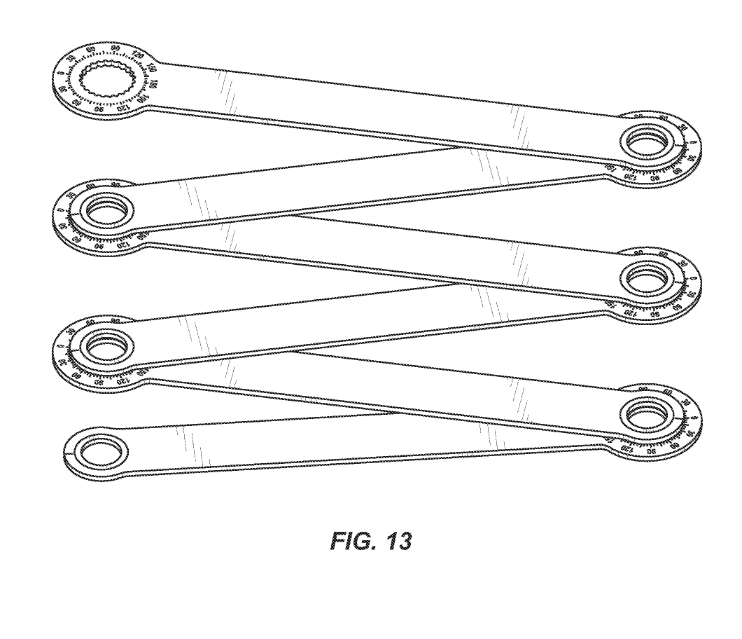

Accordingly, the tool 100 can also include angle indicators 120a-c configured to indicate angles between adjacent or directly coupled segments. For example, indicator 120a can indicate the angle 102a between adjacent segments 110a and 110b, indicator 120b can indicate the angle 102b between adjacent segments 110b and 110c, and indicator 120c can indicate the angle 102c between adjacent segments 110c and 110d. In one aspect, the indicators can include angle markings. For example, as shown in FIG. 1B, the angle 102a can be indicated by a reference marking 121a associated with segment 110a relative to an angle marking 122a associated with segment 110b. The reference marking can be printed, etched, engraved, painted, stamped, etc. on or in a segment. In one aspect, the angle marking can be disposed on, or under, an optically transparent portion 123a, such as a clear acrylic or nylon, and the reference marking can be visible through the optically transparent portion. In one embodiment (not shown), the indicator can include a rotary position sensor and a display, such as a digital display, configured to display the angle between adjacent segments. In additional embodiments as shown in FIGS. 6-13, the angle indicator can include incremental markings around the perimeter of an end of one segment with a corresponding mark in the adjacent or connected segment. The mark can be placed in a position on the adjacent segment that indicates the longitudinal direction of the segment. In this way, the relationship (i.e. angle) between the segments can be positively established by a comparison of the incremental markings around the perimeter of the first segment with the corresponding directional mark in the adjacent segment.

Referring again to the embodiments of FIGS. 6-13, it can be seen that each segment has a large end and a small end. In other words, one end can be of a first size or diameter, and the other end can be of a second size or diameter that is smaller than the first size or diameter. When a tool is made, the smaller ends of each segment can be placed on top of the larger ends of adjacent segments and then attached thereto. In this way, the above-recited angle indicator using indicator markings in relationship to a directional mark can be used.

Referring to FIG. 6, it can be seen that the small end 620 of each segment is coupled to the large end 610 of an adjacent segment. Additionally, there is a hole through each segment. As shown, the holes or opening of the large end can have serrations or protrusions along an inside portion thereof. In some embodiments, the hole or opening in the small end can also have such serrations or protrusions. In other embodiments, the inside portions of the hole or openings can be smooth, or one end smooth and one end with protrusions. In one embodiment a connector 630, such as a washer, can be coupled between the small end 620 and the large end 610 and can be configured to aid in the ability of the adjacent segments to hold a position (i.e. angle) relative to one another in which they are placed by a user. For example, in one embodiment, the connector may have serrations or protrusions that correspond to those in the holes of the large and small segment ends. Further, a fastener 640 such as a grommet or plug can be inserted through the interior of the holes of the small end, large end, and connector when all are aligned for assembly. The fastener can be sufficiently sized to allow a friction fit with the other assembled elements that is sufficient to hold the assembly together during use.

Thus, the tool can facilitate directed placement of landscape features, such as foliage items (i.e., plants, bushes, trees, and flowers), rocks, outdoor lights, etc. in a pattern or geometric relationship with respect to one another. Placement of many landscape features may be made with the tool in order to implement an overall landscape design.

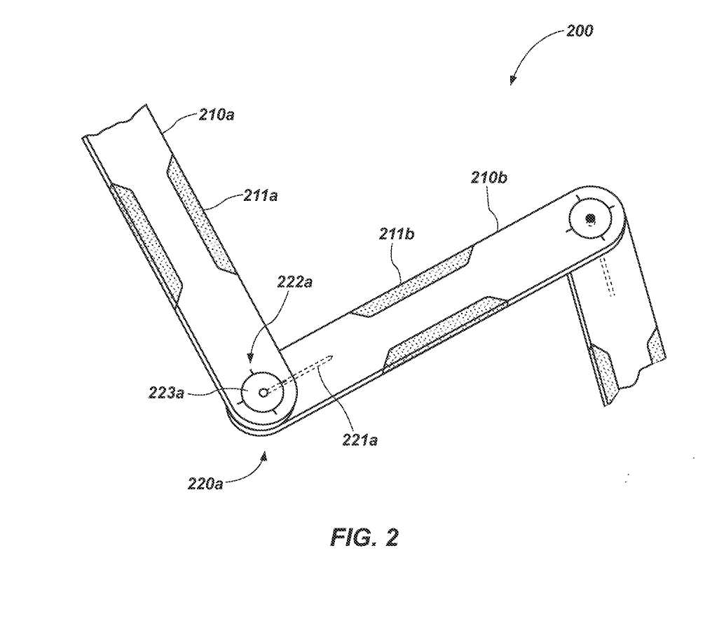

FIG. 2 illustrates a landscape feature placement tool 200 in accordance with another embodiment of the present invention. The tool 200 is similar in many respects to the tool 100 shown in FIGS. 1A and 1B. For example, the tool 200 includes adjacent segments 210a, 210b and an angle indicator 220a. In this case, however, an angle marking 222a of the indicator is not disposed on, or under, an optically transparent portion 223a as with the tool 100, but is instead disposed on a portion of the segment 210a proximate the optically transparent portion 223a. Furthermore, reference marking 221a is not only visible through the optically transparent portion, but can also be seen outside of the optically transparent portion by extending beyond the optically transparent portion along the segment 210b. In addition, one or more segments of the tool 200 can also include a grip enhancing feature 211a, 211b. For example, the grip enhancing feature can comprise a grip enhancing material, such as rubber, and/or a grip enhancing surface texture.

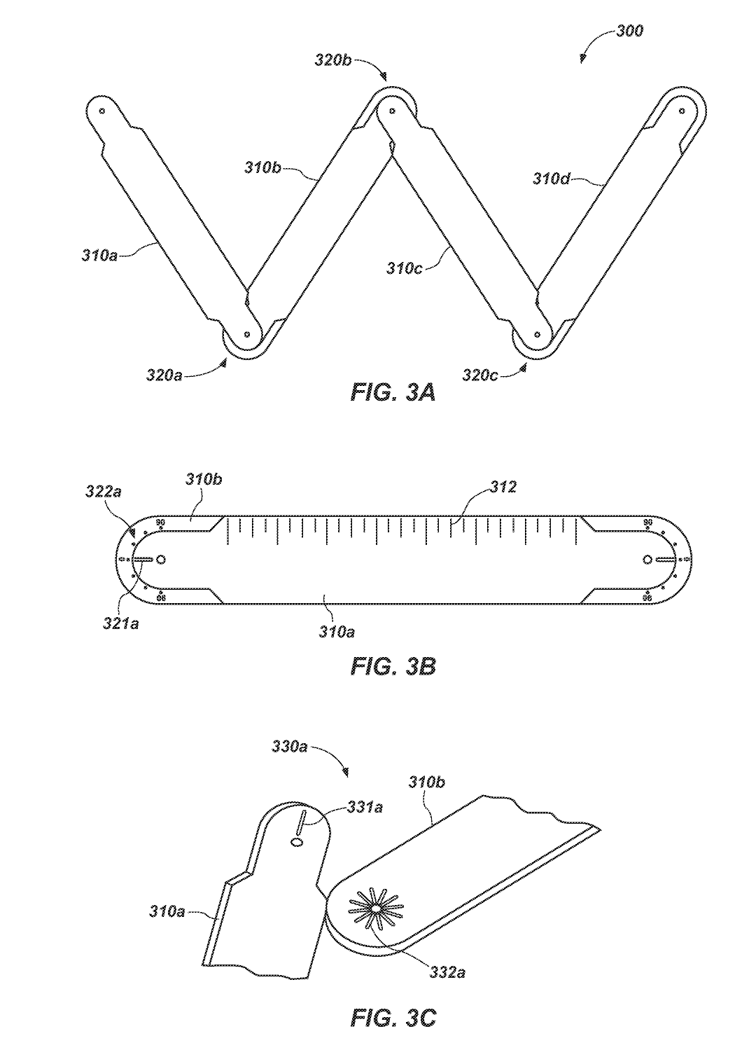

FIG. 3A illustrates a landscape feature placement tool 300 in accordance with yet another embodiment of the present invention. The tool 300 is similar in many respects to the tools 100, 200 shown in FIGS. 1-2. For example, the tool 300 includes segments 310a-d and angle indicators 320a-c. As shown in FIG. 3B, an angle marking 322a can be disposed on a portion of the segment 310b and a reference marking 321a can be disposed on a portion of the segment 310a. In addition, one or more of the segments can include length markings 312, which can be used to establish relative distances when determining a placement location for a landscape feature. The figure also illustrates that the tool can be folded into a compact storage configuration.

FIG. 3C illustrates a detailed view of a disassembled pivotal coupling of the tool 300, which shows that relative rotation of the segments 310a, 310b can be resisted by a mechanical interference between the adjacent segments. In one aspect, a detent 330a can provide the mechanical interference. For example, the detent can comprise a protrusion 331a on segment 310a and one or more recesses 322a in the adjacent segment 310b. In a particular aspect, relative rotation can be resisted at predetermined relative angles, such as 5, 10, or 15 degree increments, between adjacent segments to facilitate and maintain angle adjustments in commonly used increments.

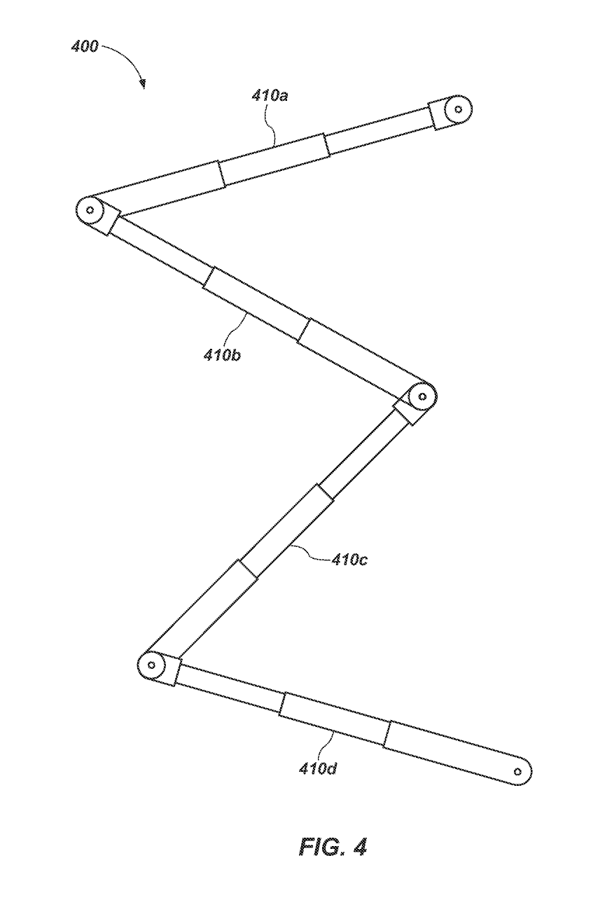

FIG. 4 illustrates a landscape feature placement tool 400 in accordance with still another embodiment of the present invention. In this embodiment, lengths of one or more segments can be variable. For example, as illustrated, segments 410a-d can have telescoping portions to vary the length. Alternatively, each segment can be of a fixed dimension (i.e. length and/or width). In one aspect, all segments in the tool can have substantially the same dimension (i.e. length and/or width). In another aspect, the segments can have different lengths. In one embodiment, each and every segment may have an identical shape and size. In one embodiment, the segments can have different shapes and/or sizes. In one embodiment, the segments can each have a length of about 12 inches to about 120 inches. In one aspect, the length can be from about 12 to about 72 inches. In a further aspect, the length can be 12, 18, 24, 30, 36, 42, 48, 54, 60, 66, 72, 78, 84, 90, 96, 102, 108, 114, or 120 inches. In another embodiment, a segment can have a flexible line, such as a string, that is extendable from an end of the segment to vary the length. It should be recognized that a landscape feature placement tool in accordance with the present disclosure can have any suitable number of segments. As such, in some embodiments of a landscape feature placement tool with a length adjustable segment, or flexible line, the tools can comprise as few as two segments. In addition, in tools with a length adjustable segment, an indicator of length for purposes of measuring the distance between one end of the segment and the other may be included. When a line, such as a retractable line is used, length or distance indicators may be provided on the line. In some aspects, the device may include only two segments even when they are not adjustable or do not include a line or string.

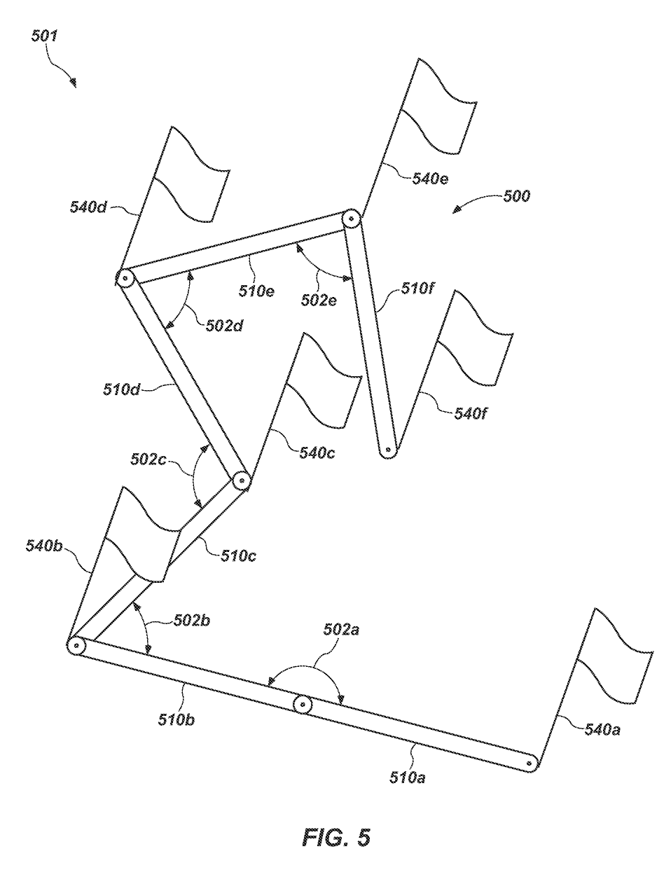

FIG. 5 illustrates a landscape feature placement system 501 in accordance with an embodiment of the present invention. The system can include a landscape feature placement tool 500 and a plurality of markers 540a-f to mark locations for placement of a landscape feature. In one aspect, one or more of the markers can comprise a flag. In use, for example, the location of a first landscape feature can be selected and marked with the marker 540a, then locations for surrounding landscape features can be determined by placing one end of the tool at the first location and then selecting an angle and distance for the next landscape feature which can then be marked with the marker 540b. Subsequent locations for additional landscape features can also be determined by repeating the above procedure and marking locations with markers 540c-f. It should be recognized that the segments 510a-f can be in any suitable orientation or angle 502a-e with respect to one another. For example, segments 510a, 510b are shown in a linear configuration with respect to one another (180 degree angle) such that the distance between markers 540a and 540b is the sum of the lengths of segments 510a and 510b. It should also be recognized that a marker can be located at any suitable position relative to a segment. For example, a marker can be placed at a midpoint of the segment 510a, if so desired. The landscape feature placement tool can therefore be used in any suitable manner to assist in the placement of landscape features.

Additionally, a method of placing a landscape feature in accordance with the principles herein is disclosed. The method can comprise obtaining a landscape feature placement tool, having a first segment, a second segment pivotally coupled to the first segment, a third segment pivotally coupled to the second segment, a first indicator configured to indicate a first angle between the first segment and the second segment, and a second indicator configured to indicate a second angle between the second segment and the third segment. The method can also comprise determining a first location for a first landscape feature. The method can further comprise placing a first marker at the first location. The method can even further comprise determining a second location for a second landscape feature relative to the first location using the landscape feature placement tool, wherein at least one of the first, second, and third segments are selectively positioned relative to the first marker and at least one of the first and second angles are selected to determine the second location. In addition, the method can comprise placing a second marker at the second location. It is noted that no specific order is required in these methods, though generally in some embodiments, the method steps can be carried out sequentially.

In some embodiments, the devices and methods used herein may be used to locate and place objects on a two dimensional surface or plane other than landscape items and the present application should not be limited thereto. For example, the tools may be used to locate and place posts for construction purposes, such as a fence or other structure, for laying out objects for a game, such as croquet, or other items such as chairs, decorations, etc. Moreover, it is understood that such tools can have any number of sizes, lengths, and/or shapes.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A landscape feature placement tool, comprising:
a first segment;
a second segment pivotally coupled to the first segment;
a third segment pivotally coupled to the second segment;
a first indicator configured to indicate a first angle between the first segment and the second segment; and
a second indicator configured to indicate a second angle between the second segment and the third segment,
wherein at least one of the first, second, and third segments are selectively positioned relative to a reference and at least one of the first and second angles are selected to determine a location for placement of a landscape feature relative to the reference.

2. The system of claim 1, wherein at least one of the first, second, and third segments includes length markings.

3. The system of claim 1, wherein at least one of the first and second indicators includes angle markings.

4. The system of claim 3, wherein the first angle is indicated by a reference marking associated with the first segment or the second segment relative to the angle marking associated with the other of the first segment or the second segment.

5. The system of claim 4, wherein the angle marking is disposed on or under an optically transparent portion and the reference marking is visible through the optically transparent portion.

6. The system of claim 4, wherein the angle marking is disposed on a portion of the first segment or the second segment and the reference marking is disposed on a portion of the other of the first segment or the second segment.

7. The system of claim 1, wherein the first indicator comprises a rotary position sensor and a display configured to display the first angle.

8. The system of claim 1, wherein relative rotation of the segments is resisted by friction between adjacent segments.

9. The system of claim 1, wherein relative rotation of the segments is resisted by a mechanical interference between adjacent segments.

10. The system of claim 9, wherein relative rotation is resisted at predetermined relative angles between adjacent segments.

11. The system of claim 9, wherein a detent provides the mechanical interference.

12. The system of claim 11, the detent comprises a protrusion on one segment and a recess in an adjacent segment.

13. The system of claim 1, wherein at least one of the first, second, and third segments comprises a grip enhancing feature.

14. The system of claim 13, wherein the grip enhancing feature comprises at least one of a grip enhancing material and a grip enhancing surface texture.

15. The system of claim 1, wherein a length of at least one of the first, second, and third segments is variable.

16. The system of claim 15, wherein the at least one of the first, second, and third segments comprises a telescoping portion to vary the length.

17. The system of claim 15, wherein the at least one of the first, second, and third segments comprises a flexible line that is extendable from an end of the segment to vary the length.

18. A landscape feature placement system, comprising:
a landscape feature placement tool, having
a first segment,
a second segment pivotally coupled to the first segment,
a third segment pivotally coupled to the second segment,
a first indicator configured to indicate a first angle between the first segment and the second segment, and
a second indicator configured to indicate a second angle between the second segment and the third segment,
wherein at least one of the first, second, and third segments are selectively positioned relative to a reference and at least one of the first and second angles are selected to determine a location for placement of a landscape feature relative to the reference; and
a plurality of markers to mark the location for placement of a landscape feature.

19. The system of claim 18, wherein at least one of the plurality of markers comprises a flag.

20. A method of placing a landscape feature, comprising:
obtaining a landscape feature placement tool, having
a first segment,
a second segment pivotally coupled to the first segment,
a third segment pivotally coupled to the second segment,
a first indicator configured to indicate a first angle between the first segment and the second segment, and
a second indicator configured to indicate a second angle between the second segment and the third segment;
determining a first location for a first landscape feature;
placing a first marker at the first location;
determining a second location for a second landscape feature relative to the first location using the landscape feature placement tool, wherein at least one of the first, second, and third segments are selectively positioned relative to the first marker and at least one of the first and second angles are selected to determine the second location; and
placing a second marker at the second location.
